(19) United States
(12) Patent Application Publication
(10) Pub. No.: US 2006/0255197 A1
(43) Pub. Date: Nov. 16, 2006

(54) End closures

(76) Inventor: Robert E. McIvor, Marquette, MI (US)

Correspondence Address: WILHELM LAW SERVICE, S.C., 100 W LAWRENCE ST, THIRD FLOOR, APPLETON, WI, 54911, US

(21) Appl. No.: 11/415,507

(22) Filed: May 2, 2006

Related U.S. Application Data
(60) Provisional application No. 60/680,766, filed on May 13, 2005.

(51) Int. Cl. B02C 19/00

(52) U.S. Cl. 241/226

(57) ABSTRACT

Sizing apparatus adapted to modify particle size. First and second sizing rolls are mounted parallel to each other and define a trough therebetween which receives material to be worked. The material moves through the trough toward a gap between the rolls. An end closure is adjacent first and/or ends of the sizing rolls, and closes off an end of the trough. The end closure comprises a support structure, and an array of interface elements mounted to the support structure and spaced with respect to each other to provide, optionally in combination with the support structure, an effectively continuous interface surface to contact the material being worked. The interface elements comprise working surfaces which move in cooperation with movement of the material.

### BACKGROUND

This invention relates to comminution, as by compaction, of solid particles, of relatively larger average mass per particle, to make a larger number of particles of relatively smaller average mass per particle. In the alternative, the invention relates to agglomerating relatively smaller size particles to make a compacted ribbon of such particles, or briquettes of such particles. More specifically, the invention finds substantial use in comminuting, especially in compactive size-reduction, or otherwise effecting size-reduction in ores and other mineral-rich materials from which useful compositions can be extracted, by passing the respective material between two size-reduction rolls. Thus, this invention finds substantial application in the processing of minerals, generally near the mine site from which the material has been extracted. In the alternative, this invention.

Further, the invention finds substantial application in the processing of particulate material into larger, and relatively controlled-size products, by forming controlled-size agglomerates of the particles which are fed to the process.

In general, all inanimate objects are in some form derived from the earth. Such extraction begins with the removal of a mineral from the earth in a process known generally as “mining”. Generally, mining operations are directed at a body of matter which is relatively richer in the material being extracted, and the mining operation is carried on at a focused location called a “mine”. The resultant raw material as extracted from the earth is generally referred to as ore.

As extracted from the earth, ore typically occurs in a form which is generally not useful to the consuming public. However, the ore is of a composition which, if appropriately processed, can be used to make products which are of use to the consuming public.

Accordingly, the ore is subjected to one or more, typically many, processing operations which convert the ore, develop ore extracts, combine the ore extracts with other materials, and thus make products which are useful to at least a segment of the consuming public.

Typically, the ore includes not only the material which is desirable for extraction into useful products, but is mixed with one or more, typically many, other materials which are of little or no value as mineral extractions in the mining operation. Thus, typically, ore is first concentrated using various processes at or generally near the mine location, thus to remove a substantial portion of the non-valued material from the ore, to produce a mineral concentrate. Such mineral concentrate is then further processed to make valuable products.

In the mining operation, the primary objective is to extract substantial volumes of the material/ore of interest from the earth. Typical extraction processes include blasting, breaking with shovels, plows, boring machines, and the like, whereby the material extracted is characterized by a wide range of particle sizes, from very small e.g. powder, to very large e.g. a ton or more. In order to process the so-extracted ore to retrieve the materials of interest, it is common practice to comminute the particles so as to produce a mineral mass having a relatively uniform, and relatively small, particle size so as to position the valued material relatively closer to the surfaces of the particles. Such surface proximity facilitates separating the valued material from the waste material. For example, particle size may be 0.5 inch or less, 0.25 inch or less, 0.13 inch or less, 0.005 inch or less, 200 mesh or less. Such particle size reduction facilitates various processes which separate the valuable materials in the ore from the non-valuable materials in the ore. By conducting the initial concentration processes at the mine, the waste material can be returned to the mine from which it was extracted, thus to limit the net volumetric change in earth disturbance at the mine site, as well as avoiding spread of environmental impact concerns to sites away from the mine.

In the alternative, such comminution processes can be used merely to reduce the particle size of a material which is already in a desired level of concentration, but where it is desirable to reduce the particle size. Such simple comminution, unrelated to separation processes, is relatively common practice in the production of cement and other products.

This invention is directed to improving the efficiency of the process of comminuting or compacting/briquetting particle sizes, especially for producing a mass of ore or other mineral composition having a relatively smaller range of particle sizes, where the primary difference is that the overall average size of the mass of particles is reduced in magnitude.

As a process of interest in the invention, it is common practice to arrange a pair of comminuting rolls, or compaction rolls, in parallel relationship with respect to each other, with a gap between the rolls. The particulate material is fed to the gap between the rolls. The rolls are rotated in cooperation with each other, in directions whereby the rolls cooperatively draw the feed particles into the gap between the rolls, thereby subjecting the particles to extremely high pressure, usually provided hydraulically by one of the rolls, the other roll being fixed, and thus grinding, crushing, compacting, and/or briquetting, the particles.

The ends of the rolls are aligned with each other, and the axes of rotation of the rolls are parallel to each other, so as to form a trough-shaped feed structure, which trough guides the particles to the gap, the gap being the location where the rolls most closely approach each other. Rotation of the rolls draws the feed material to the gap.

Typically, the particles being comminuted are smaller in diameter than the distance between the rolls at the gap. So the comminution of the particles is not effected by crushing of the particles between the surfaces of the rolls. Rather, the particles which are adjacent a particular roll working surface pass the roll pressure to adjacent particles so as to make a compacted bed of particles which is drawn by the rotation, of the surfaces of the rolls, through a compacting zone which is increasingly reduced in cross-section size as the particles move closer and closer to the gap.

Restated, according to the roughness of the particle surface, according to the roughness of the working surfaces of the rolls, the rotation of the rolls, draws a particle toward the gap and in so doing draws a collection of such particles into a progressively shrinking space between the rolls as the particle moves closer to the gap. As the particle moves through the shrinking space, the surrounding particles tend to move together such that a given mass of material is moving through a shrinking volume of space. Accordingly, the pressure applied to particles at the working roll surfaces is transferred, particle-to-particle, throughout the mass of particles which is being drawn to the gap. This particle-to-particle pressure radiates hemispherically from respective loci at the working surfaces of the rolls. Because of edge effects, the working pressure is generally less at the edges of the rolls than at loci away from the edges of the rolls.

In some instances of conventional practice, the ends of the trough are left open such that material in the trough can fall out of the trough at the roll ends without traversing the gap. In such instances, the particle-to-particle working pressure is substantially lower adjacent the ends of the trough than at loci more displaced from the ends of the trough. Accordingly, the material which passes through the gap adjacent the ends of the trough is worked less than the material which passes through the trough at loci more displaced from the ends of the trough. As a result, the rolls are not working at their maximum comminution productivity. In addition, the particles produced by the lower pressure at the ends of the trough experience a lesser degree of comminution, or compaction, whereby the material produced adjacent the ends of the trough is lesser-quality product; and more of such lesser quality product may need to be recycled for further processing.

In other embodiments of conventional practice, each end of the trough is closed off by a stationary end closure plate which is positioned closely adjacent the ends of the rolls at the respective end of the trough. Such closure plates are known in the trade as “cheek plates”. The cheek plates are positioned against, or held in close proximity to, the ends of the rolls, at and above the gap, and are held in the desired positions, generally in sliding contact with the roll ends, by side-loading devices, such as spring-activated structures or pneumatic-activated, or hydraulic-activated, or fixed structures. Thus, there is a constant side-loading force urging the cheek plates against the ends of the rolls, and/or on the material being drawn through the gap, thus to prevent particulate material from by-passing the comminuting gap by traveling a path about the ends of the rolls, such as between the cheek plate and an end of a roll.

Such closure of the ends of the trough is generally effective to retain the particles in the trough and force the particles to traverse the gap. By so closing the ends of the trough, and thereby directing the particles at the ends of the trough to traverse the gap, the cheek plates effectively reduce the extent of the lateral pressure differential at and adjacent the ends of the trough.

While efforts are thus made to seal the ends of the trough, the cheek plates wear rapidly from the abrasion caused by the constant friction between the cheek plate and the end of the roll, as well as by the abrasion effected by the constant movement of the particles past the stationary cheek plate in the trough. Since most ores and other minerals are quite abrasive, the rate of wear on the cheek plates is quite rapid, whereby openings develop between the cheek plates and the roll ends, which reduces the effectiveness of the cheek plates. Thus, cheek plates must be replaced quite frequently. The contact of the stationary cheek plates on the sides of the moving rolls also causes substantial wear on the sides of the rolls. Even so, common practice in the mineral-processing industry teaches that a substantial fraction of the ore effectively by-passes the gap by traversing a path about the ends of the rolls and between the ends of the rolls and the cheek plates.

Accordingly, it would be desirable to provide end closures for the trough, such as an improved cheek plate, cheek plate equivalent, or other end closure.

It would further be desirable to provide end closures for the trough, such as an improved cheek plate, cheek plate equivalent, or other end closure, wherein the end closure experiences a lower incidence of abrasion.

It would still further be desirable to provide end closures wherein the operation of the end closure enhances maintenance of surface-to-surface contact between the end closure and the ends of the respective comminuting rolls, by reducing abrasive wear on the end closure.

### SUMMARY OF THE DISCLOSURE

In sizing apparatus which is adapted to modify particle size, first and second sizing rolls are mounted parallel to each other and define a trough therebetween adapted to receive material to be worked by the sizing apparatus. The material moves through the trough toward a gap between the sizing rolls at the locus of closest approach of the rolls to each other. An end closure is positioned adjacent first and/or second ends of the sizing rolls, and generally closes off an end of the trough. The end closure comprises a support structure, and an array of interface elements mounted to the support structure and spaced with respect to each other so as to provide, optionally in combination with the support structure, an effectively continuous contact surface to contact the material being worked. The interface elements comprise working surfaces which move in cooperation with movement of the material through the trough toward the gap and with the movement of the sizing rolls.

In some embodiments, the sizing apparatus comprises first and second ones of the end closures, disposed at opposing ends of the trough so as to prevent solid particulate material in the trough from traveling through the ends of the trough and thus by-passing the gap.

In some embodiments, the moving surface elements rotate about respective axes of rotation.

In some embodiments, the end closure comprises support structure, the moving of the moving surface elements comprises translational movement relative to the support structure.

In some embodiments, the sizing rolls comprise size reduction rolls.

In some embodiments, the sizing rolls comprise agglomeration rolls.

In some embodiments, the apparatus further comprises a second end closure adjacent second ends of the first and second rolls, thereby generally closing off both first and second ends of the trough.

In some embodiments, the array of interface elements comprises an endless track.

In some embodiments, the array of interface elements comprises an array of rollers, and the axes of rotation of the rollers are all generally parallel to each other.

In some embodiments, the array of interface elements comprises an array of rollers, wherein axes of rotation of a first set of the rollers are aligned with, and parallel to, each other, and wherein axes of rotation of a second different set of the rollers are aligned with, and parallel to, each other and not parallel to the axes of rotation of the first set of the rollers.

In some embodiments, the array of interface elements comprises an array of rollers positioned, in combination, in end-to-end relationship to each other and in side-by-side relationship to each other.

In some embodiments, the array of interface elements comprises an array of balls mounted for polyaxial rotation, each ball being optionally mounted for polyaxial rotation.

In a second family of embodiments, the invention comprehends an end closure assembly adapted and configured to close off an end of a material compacting trough between first and second sizing rolls, the end closure comprising an endless track; and a support structure. The endless track is mounted about the support structure. The support structure and the endless track, as so mounted, define an endless path of travel of the track about the support structure.

In some embodiments, the endless path of travel comprises an engagement section and a non-engagement section, a ratio of height to width of the engagement section is about 0.5/1 to about 2/1.

In some embodiments, the support structure comprises first and second end rotating elements, rotating on fixed axes of rotation and defining nodes of the endless path.

In some embodiments, the end closure further comprises intermediate support structure between the first and second end rotating elements, supporting the endless track along an engagement portion of the endless path.

In some embodiments, the intermediate support structure comprises at least one intermediate rotating element supporting the endless track along an engagement portion of the endless path.

In other embodiments, the intermediate support structure comprises a support plate supporting the endless track along an engagement portion of the endless path.

In a third family of embodiments, the invention comprehends an end closure assembly adapted and configured to close off an end of a material compacting trough which leads to a gap of closest approach of first and second sizing rolls to each other, the end closure comprising a support structure; and an array of interface elements spaced with respect to each other so as to provide, optionally in combination with the support structure, an effectively continuous contact surface to the material being worked, the interface elements comprising working surfaces which move in cooperation with movement of the material through the trough toward the gap.

In some embodiments, the end closure assembly comprises an array of balls mounted for polyaxial rotation, and rollers mounted for rotation about fixed axes of rotation.

### BRIEF DESCRIPTION OF THE DRAWINGS

FIG. 1 shows a side elevation view of a set of comminuting rolls using prior art cheek plates.

FIG. 2 shows a top view of the comminuting rolls and cheek plates of FIG. 1.

FIG. 3 shows a pictorial view of a first embodiment of end closures of the invention, using multiple support rollers.

FIG. 4 shows a side elevation view of a set of comminuting rolls as in FIG. 1, using end closures as in FIG. 3.

FIG. 5 shows a top view of the comminuting rolls and end closures of FIG. 4.

FIG. 6 shows an end view of the comminuting rolls and end closures of FIGS. 4 and 5.

FIG. 7 shows a pictorial view of a second embodiment of end closures of the invention, using a support plate structure between end rollers.

FIG. 8 shows a rectangular cheek plate with a bank of rollers designed to be positioned adjacent the end of the trough.

FIG. 9 shows an end closure largely resembling the cheek plate of FIG. 8 but wherein the backing plate resides entirely behind a bank of rollers which can be placed against the end of the trough.

FIG. 10 shows an end closure as in FIG. 9 and wherein multiple rollers are disposed end-to-end at respective elevations on the end closure.

FIG. 11 shows an end closure as in FIG. 10 but where the side rollers are oriented at an angle to central rollers in the upper portion of the end closure.

FIG. 12 shows an end closure as in FIG. 10, but wherein the individual rollers are substantially shorter in length, so as to appear more like wheels than the elongate rollers of e.g. FIGS. 8 and 9.

FIG. 13 shows an end closure as in FIG. 12 and wherein a top portion of the end closure presents a stationary metal surface for interfacing with the material being worked, and wherein a bottom portion of the end closure presents wheels and/or rollers for interfacing with the material being worked.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

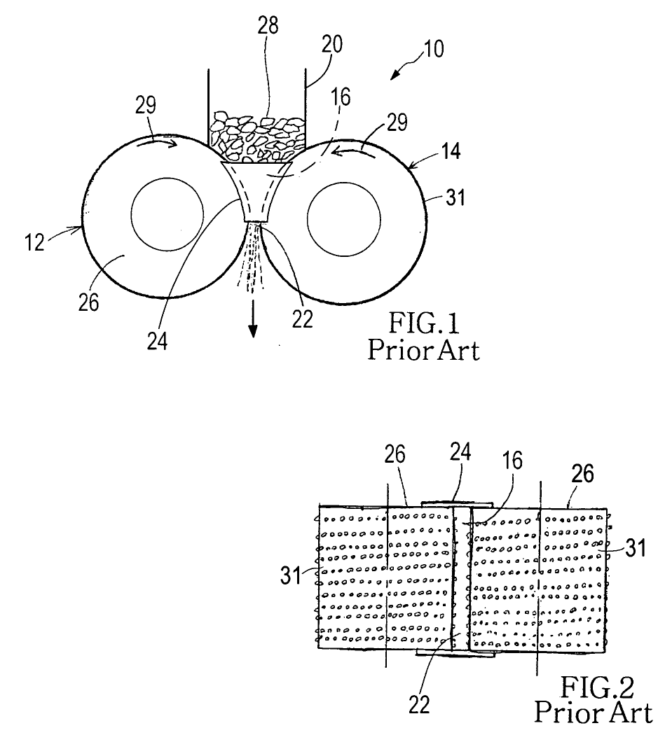

FIGS. 1 and 2 illustrate a representative embodiment of comminuting roll assemblies 10 which include first 12 and second 14 comminuting rolls arranged parallel to each other, spaced apart so as to define a trough 16 therebetween extending down from a feed material hopper 20 and terminating at a gap 22 between the two rolls where the rolls most closely approach each other. Conventional cheek plates 24 are biased against opposing ends 26 of the comminuting rolls, and form opposing ends of trough 16. Material 28 to be comminuted is fed to the comminuting roll assembly by the hopper.

As illustrated in FIG. 1, comminuting rolls 12 and 14 rotate in opposing directions, shown by arrows 29 such that the cylindrical working surfaces of the rolls rotate toward each other in the vicinity of trough 16, thus to draw material 28 toward gap 22. Material 28 is also drawn toward gap 22 by gravity, and/or forced there by pressure, such as pressure provided by a screw feeder, where, as illustrated in FIGS. 1 and 2, hopper is located at a higher elevation than gap 22.

Gap 22 is sized, e.g. the distance between the cylindrical outer working surfaces 31 of rolls 12 and 14 is set, so as to maximize or control the pressure on the particles in gap 22. A typical distance between rolls 12 and 14, across gap 22 is about 0.5 inch but can vary according to the application.

The conventional cheek plates illustrated in FIGS. 1 and 2 are pieces of flat sheet metal having constant thicknesses. Cheek plates 24 are mounted in fixed positions such that a given portion/area of the surface of a respective one of the cheek plates maintains constant contact with the respective one of rolls 12, 14, as the roll rotates.

While the conventional cheek plate is in such constant contact with the end of the roll, and the roll is rotating, material 28 to be comminuted is being fed, along the full length of the trough, toward and into the gap, including at the ends of the trough. As the material is fed toward the gap, the material at the ends of the trough rubs, scrapes the side/face of the cheek plate which faces the trough, resulting in substantial abrasive wear on the cheek plate. Some fine portions of the material can work its way between the cheek plate and the side of the roll.

As the cheek plate continues to wear, this space between the cheek plate and the rolls gets larger, allowing more material to get through that space and around the intended working gap between the rolls. Also as the space gets larger, larger size particles can get through. The increased particle flow through the space also increases the wear rate, and jeopardizes maintenance of the pressure on the material between the rolls in the vicinity of the ends of the trough. Thus, the portion of the cheek plate which interfaces with the end of the roll experiences wear from its frictional engagement with the end of the turning roll and from abrasion imposed by those material particles which enter the space between the cheek plate and the roll.

In either scenario, the quantity of material 28 which by-passes gap 22 is of sufficient quantity to represent a significant economic loss to the operation of the comminuting process, and such by-pass material may, as well, contaminate the resultant product with oversize particles.

The constant contact of the respective portion/area of the cheek plate, if any, with the moving/rotating end portion of the roll, causes ongoing wear of the cheek plate. Further, that portion of the cheek plate which is directly in contact with material 28 at the ends of the trough causes abrasion and corresponding wear of the cheek plate at those respective surfaces.

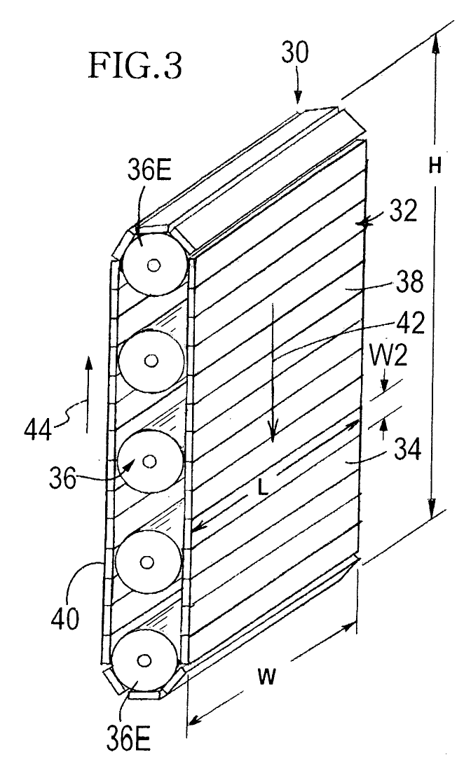

Turning now to the invention, FIG. 3 shows an end closure assembly 30 of the invention, in place of a conventional cheek plate, which end closure assembly includes an endless track 32 which has a width “W”. Track 32 is made up of a plurality of treads 34. Each tread has a length “L” which corresponds generally with the width “W” of the track, and a width “W2” which extends along the height “H” of the track. Height “H” is generally of a magnitude to block spillage of material from trough 16 at maximum loading of the trough.

Treads 34 are arranged edge-to-edge with respect to each other along the length of the track so as to collectively define an endless path which corresponds generally, in the illustrated embodiment, to a flattened ellipse. Treads 34 are connected to each other so as to maintain the treads in generally edge-to-edge relationship, by suitable linkages, not shown, whereby the treads function in cooperation with each other so as to define track 32 as a single subassembly of end closure assembly 30.

Track 32 is mounted about two or more mounting rollers 36. Rollers 36 are arranged with respect to each other so as to define nodes along the endless path traversed by endless track 32. In the illustrated embodiment, rollers 36 define ends of the extent of travel of the “flattened ellipse” path described above.

The path traveled by track 32 has an engagement section 38, and a non-engagement section 40. At any point in time, a first portion of the track is in the engagement section of the path, and a second remainder portion of the track occupies the non-engagement section of the path. The respective portions of the track move into and out of the engagement section as the track traverses along the path. Thus, at any point in time, the track has an engagement section 38 and a complementing non-engagement section 40.

Engagement section 38 is defined as that portion of the track which does come in contact with material 28, or which may come in contact with material 28, as the material is traversing through the trough 16 toward gap 22. The remainder of the travel path, which will not come into contact with the material being comminuted, is defined as the non-engagement section 40, of the travel path, correspondingly the non-engagement section of the track.

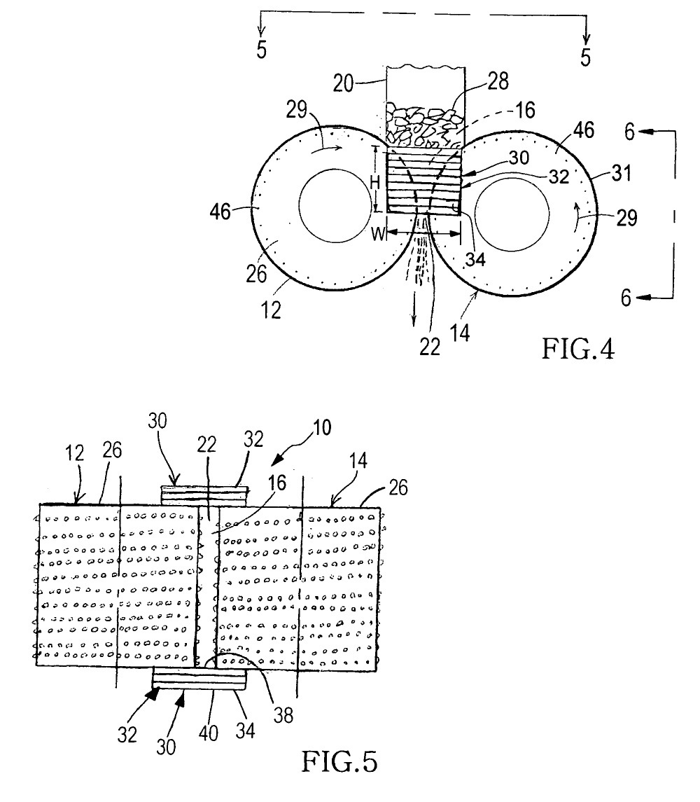

The engagement section of the travel path is configured so as to define a generally closed joinder between track 32 and some interface structure which represents an end of trough 16. Typically the ends of rolls 12, 14 provide the interface structure; such that the engagement section of the travel path represents a joinder, or other proximity between track 32 and the ends of rolls 12, 14, as illustrated in FIGS. 4 and 5. As appreciated by those skilled in the art, the comminution of hard rock, as discussed herein, is accompanied by high levels of forces and resistances, exerted by the highly abrasive material which is being processed. In conventional machinery, such forces inherently cause a recognized level of openings, gaps, and the like between such closures as are described at the ends of trough 16. Thus, a properly working end closure assembly of the invention substantially reduces the edge affect, while not necessarily preventing all material from by-passing gap 22.

Referring now especially to FIGS. 3 and 5, engagement section 38 is a generally planar portion of the travel path, such that the planar surface of the track at the engagement section interfaces with generally planar portions of ends 26 of rolls 12, 14, alternately a portion of the end 26 of each roll wherein the interfacing portion of the roll is located in an imaginary plane and serves as a closure at the end of the trough, between engagement section 38 and the end of the roll.

Engagement section 38 is generally that portion of the travel path where the track interfaces with the material 28 which is being comminuted, as well as with portions of the ends of rolls 12, 14. Accordingly, the configuration of the engagement section must be compatible with such interface, with the roll ends and with material 28, so as to provide a “seal” between the ends of the rolls and the trough, thus to impede escape of material from the trough except through gap 22, whereby the configuration of the engagement section is to at least some extent defined by the collective configurations of the ends of rolls 12, 14, as well as any appurtenances to the ends of the rolls. As used herein, “seal” includes a closure which accommodates conventionally-used surface finishes in the comminuting industry, as well as normal wear and tear on such apparatus during its normal use life.

While it is important that engagement section 38 have a configuration which is compatible with an ongoing interfacial relationship with rolls 12, 14, the configuration of the non-engagement section is not so limited. Rather, the sole function of the non-engagement section of the travel path is to carry the respective treads back to the engagement section of the travel path. Thus, the non-engagement section can be as simple as the straight-line run shown, or can be otherwise configured in accord with benefits defined by any such other configuration/outline.

In the embodiment shown in FIG. 3, track 32 travels in a downward direction, as shown by arrow 42, along the engagement section and travels in the opposite direction, shown by arrow 44, in the non-engagement section. That portion of the travel path which turns about end rollers 36E is curved, and thus is not part of the engagement section, whereby such portion of the travel path is, by default, part of the non-engagement section.

The length of the endless path generally corresponds to the length of endless track 32. A tensioning device, not shown, can be used as desired to provide modest tension to the track thus to encourage the track to maintain a planar travel path along at least the engagement section of the path. Further to maintenance of a planar travel path along the engagement section of the path, support bars and/or plates can be positioned behind the path of travel between rollers 36, so as to prevent lateral pressure, applied by material 28, from displacing the track from its desired planar path of travel.

End closure assembly 30 is positioned relative to roll 12, roll 14, trough 16, and gap 22 such that the top of the end closure assembly closes off the respective sides of the mass of feed material 28 which is being fed through gap 22. In general, the top of end closure assembly 30 corresponds with the bottom of the feed hopper 20 which feeds material 28 which is being comminuted. The bottom of end closure assembly 30 generally extends to, and slightly below, gap 22, at the locus of closest approach of rolls 12, 14 to each other.

The width “W” of end closure assembly 30 is generally centered on trough 16, and thus is typically centered on gap 22. Magnitude of width “W” of the end closure assembly is sufficient to cover the width of trough 16 at ends 26 of rolls 12, 14, up to the top of the working height of trough 16 as generally defined where the lower edges of hopper 20 meet upper portions of rolls 12 and 14. As illustrated in FIG. 4, the top of trough 16, in which material resides, generally extends about ⅔ to ¾ of the distance between the gap 22 and the tops of rolls 12, 14.

Further to FIG. 4, and considering that rolls 12, 14 are cylindrical, the ratio of height “H” to width “W” of at least the engagement section of cheek plate assembly 30, is typically about 1/1, with a typical range of about 0.5/1 to about 2/1. In general, the width of the engagement section is about the same as the width “W” of the track, and the height of the engagement section is about the same as the height “H” of the track. Because of the ongoing movement of the treads about the travel path, the composition of the engagement section changes along with the travel of the treads. FIG. 4 illustrates that the portion of the engagement section which is shadowed by the ends of the rolls 12, 14 is not in general working contact with the material 28 being comminuted.

In general, the invention is a device which is used for containing the feed material 28 in trough 16 between a set of comminuting rolls 12, 14 or other size-modifying rolls. In embodiments not shown, such size-modifying rolls are used in compactor machines and/or briquetting machines, whereby cheek plates of the invention are beneficially employed. Such compactors condense less dense starting material, such as potash, into a compact ribbon or so-called “flake”. Such briquetting machines combine a mass of fine-size particulate material such as charcoal powder, into briquettes which are substantially larger than any of the powder particles so agglomerated. Thus, the moving cheek plate assemblies of the invention can be used for a variety of size-modifying processes, namely for example and without limitation,
(i) to reduce particle size,
(ii) to increase density in general by consolidating elements of an article about themselves while removing air from between the elements of the product, and
(iii) to agglomerate relatively smaller-size particles into resultant relatively larger-size units of end product.

In general, in end closures of the invention, the surface of the track which contacts the material 28, namely at the engagement section of the travel path of the track, and which normally touches or is most closely adjacent the sides of the rolls, moves generally in the same direction as the material 28 which is being comminuted, and generally in the same direction as the ends 26 of the rolls 12, 14 are rotating at gap 22.

The contacting surface of the cheek plate, namely that portion of the track which is passing through the engagement section at a given point in time, is made up of a segmented or otherwise flexible crawler-type track, or tracks, or a surface structure or assembly which otherwise facilitates movement of material 28 toward gap 22 while generally closing off the end of trough 16. The track, itself, is made up of continuous or segmented and connected pieces of a continuous track which circulates on rollers 38 which are mounted on a suitable frame and/or on suitable axles.

The material of which the working surface of track 32 is comprised, namely that surface which interacts with material 28 and ends 26 of the rolls, can be a hard metal e.g. having hardened contact surfaces. In the alternative, the material of which the working surfaces of the treads 34 are comprised can be a different abrasion resistant, e.g. non-steel material such as an abrasion-resistant urethane or rubber. Similarly, the contacting or nearby adjacent wearing edges of the ends of rolls 12, 14 may be made of the same or similar material.

Where the material of track 32, which receives the abrading action of the ore and/or ends of rolls 12, 14, is sufficiently flexible as well as being sufficiently abrasion resistant, track 32 can be defined in the structure of a unitary endless belt rather than a series of treads 34. Thus, as used herein, and to the extent sufficiently abrasion-resistant materials are available, the word “track” includes single-piece, e.g. endless, belts mounted on rollers 36 or other belt guide material. Correspondingly, where a belt is used as track 32, corresponding belt tracking and guiding structures are used in place of rollers 36, whereby “rollers 36” includes such equivalent belt tracking and guiding structures to the extent such guiding and tracking structures are used with an endless belt.

Track 32 is driven about the endless path, and thus through its contact with material 28, by the movement of material 28 which is in contact with the track. Track 32 may also be driven, in part, by any contact with the moving/rotating ends of rolls 12, 14.

Typically, no internal motive force, such as a motor, is used to drive track 32. Rather, rotation of rolls 12, 14 applies pressure to material 28, causing the material to move downwardly in trough 16 toward gap 22. Rotation of rolls 12, 14 in combination with the pressure applied by end closure 30 against the ends of the rolls also applies a downward frictional force on track 32 at engagement section 38. In addition, the frictional engagement between material 28 and track 32 adds a further incremental downward force on track 32 at engagement section 38. This combination of forces applied by the movements of roll ends 26 and movement of material 28 results in the track moving in a generally common direction with the movement of material 28 e.g. toward gap 22.

Further, track 32 can be driven by a mechanical connection between rolls 12, 14 and the track. For example, a plurality of pins 46, or other engaging structure, is represented as extending outwardly from ends 26 of rolls 12, 14 in FIG. 4, adjacent the outer perimeters of the rolls. Pins 46 engage slots or other receptacles (not shown) in track 32, optionally in treads 34. In such embodiments, the driven rotation of rolls 12, 14 causes the moving pins 46 to engage respective slots in track 32, thereby to drive track 32, treads 34 at a speed consistent with the speed of rotation of rolls 12, 14.

In the alternative, track 32 can be driven about its travel path by e.g. an electric motor which is drivingly connected to one or more of rollers 36. In such case, the respective roller or rollers 36 is typically a sprocket drive roller. Alternatively, the motor can be located internally to one of the rollers.

A set of five rollers 36 is shown in e.g. FIG. 3, visible at the near end of end closure assembly 30. Rollers 36 extend generally to the distal end of the end closure assembly, e.g. in association with the distal ends of treads 34. In the alternative, a plurality of shorter rollers 36 can be disposed along the width of the track in place of each shown single elongate roller, as desired, in order to provide a desired level of back-up support to the treads/track.

The assembly is held in position by fixed mounting, or springs, and/or weighted levers, similar to the positioning apparatus which is used to support and bias conventional, fixed side cheek plates. The mobile portions of the end closure assembly can be an internal portion of an otherwise fixed cheek plate. Thus, the portion which interfaces with material 28 is primarily represented by mobile elements of the end closure, but there is still a portion of the end closure which is fixed relative to motion of rolls 12, 14 and/or material 28.

An advantage of end closure assemblies of the invention is that the contacting, e.g. wear surface, namely at the engagement section of the travel path, moves in generally the same direction as the material 28, and in generally the same direction as the respective surfaces 26 of the rolls with which the moving end closure is engaged, thereby eliminating most of the relative motion and wear between the contacting surfaces of the end closure and the material 28 as well as between the end closure and rolls 12, 14, and thereby eliminating a substantial portion of the wear which is conventionally associated with such contact at the end of the trough.

Whether the contact elements of the end closure assembly are moved by the drag between the moving treads 34 and the material or the ends of the roll, or whether the moving treads 34 are moved by a driving assembly, wear on treads 34 is generally defined in terms of the relative movement between the engagement section of the track and material 28, and the relative movement between the track and the rotational motion of the contacting portions of the ends of rolls 12, 14.

In either case, and even considering that movement of the ends of rolls 12, 14 is rotational and the movement of the moving treads is linear at the engagement section, the relative motion between the moving treads and the roll or between the moving track and the material, is greatly reduced when compared to the relative motion between a conventional, e.g. stationary, cheek plate and the material and between such stationary cheek plate and ends 26 of rolls 12, 14.

Cheek plate 30 provides for forceful containment of material 28 between the rolls, e.g. at the ends of trough 16, thus increasing the amount of material which is subject to comminuting compacting/briquetting between the rolls, and reducing the “bypass fraction” of untreated feed material.

FIG. 7 shows a tracked end closure assembly as in FIG. 3, but wherein support rolls 36, between the end rolls 36E, are replaced by a support plate 48. Support plate 48 extends under substantially the full length and full width of the engagement section of the track whereby substantially the full length and width of the engagement section of the track is supported by support plate 48. Support plate 48 can include one or more longitudinally extending alignment grooves 50, and track 32 can include corresponding connecting structure (not shown) connecting the treads to each other, or other protuberances, which ride in alignment grooves 50. Such correspondence and connectivity between grooves 50 and protuberances assists in maintaining alignment between track 32 and the support structure defined by rollers 36E and support plate 48.

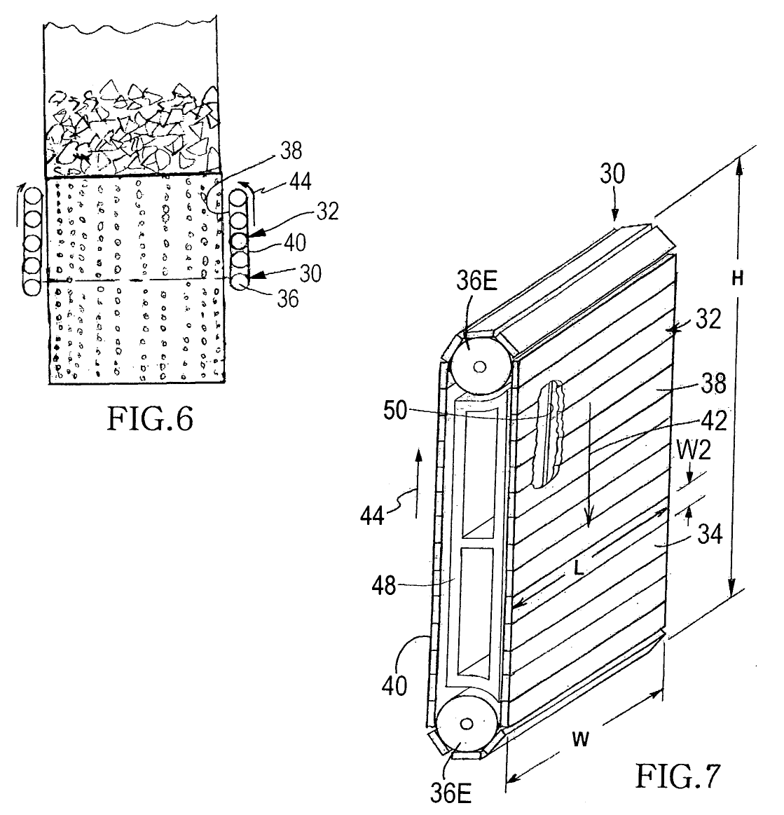

The critical feature of trough end closure assemblies of the invention is that a respective such closure assembly provides a moving interface at the end of the trough, which moving interface can advance with material 28 as the material moves downwardly toward gap 22. FIGS. 3-7 show track-based end closure structures wherein the treads 34 in track 32 move translationally downwardly in the engagement section according to frictional engagement with both material 28 and ends 26 of rolls 12, 14.

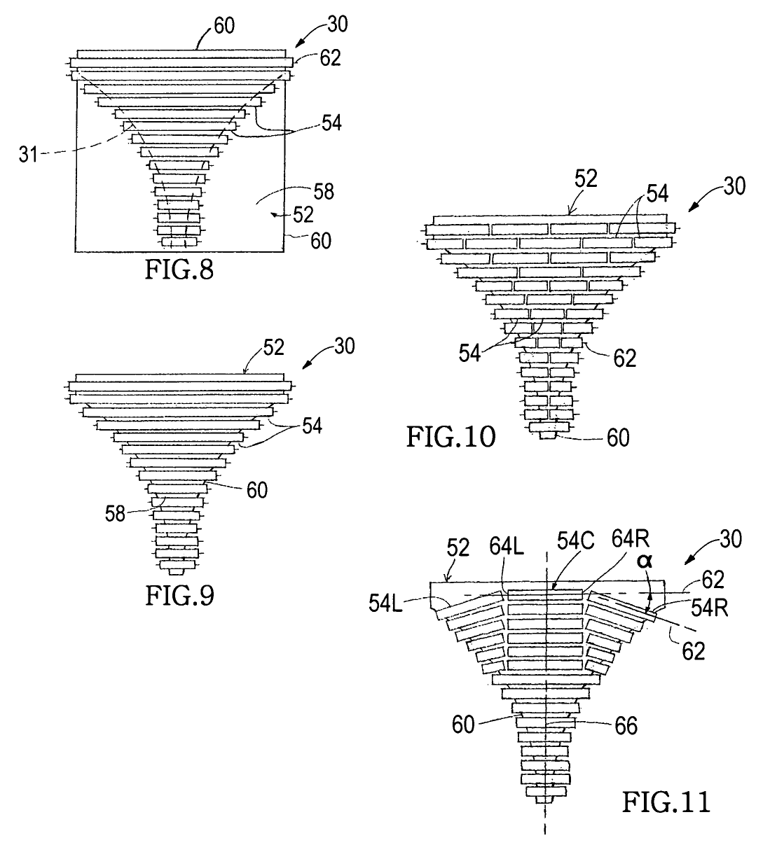

FIGS. 8-12 illustrate embodiments of the invention wherein fixed-axis rotating elements are mounted to an underlying non-moving support structure. In such embodiments, a substrate plate 52 is fixedly mounted to support structure so as to be presented at the end of trough 16. A plurality of rotating rollers, wheels, or balls, all designated severally as 54, are mounted on the substrate so as to present the rollers, wheels, or balls as the contact interface with material 28, and wherein the rotation of the wheels, rollers, or balls comprises the movement which facilitates downward movement of material 28 while relieving the conventional amount of friction which is normally experienced at a fixed cheek plate.

Another way of describing the structure of the end closures 30 of FIGS. 8-12 is as fixed cheek plates which have embedded therein, namely mounted thereto, rotating wheels, rollers, and/or balls which are presented as the primary contact surfaces which interface with material 28.

FIG. 8 shows a representative illustration of a generally rectangular end closure assembly 30 comprising a generally rectangular substrate plate 52, and a plurality of rollers 54 mounted to the substrate plate. Substrate plate 52 has a major surface 58 which faces the reader in FIG. 8, and a plurality of outer edges 60. Rollers 54 have generally horizontally-oriented axes of rotation 62 and are generally oriented parallel to each other. In FIG. 8, the cylindrical surfaces of rollers 54 project, from major surface 58 toward the reader, toward the reader. In some implementations, substrate plate 52 has a generally planar surface 58 and rollers 54 are mounted between surface 58 and the reader. In other implementations, surface 58 defines cavities (not shown) sized and configured to receive rollers 54 thereinto, and wherein a first portion of the cylindrical surface of a respective roller is received into a respective cavity and a second portion of the cylindrical surface of the same roller projects outwardly beyond surface 58 so as to provide an interface surface which contacts material 28 at loci displaced from surface 58.

In either case, the surfaces of rollers 54 define at least a portion of the contact interface with the material at the end of trough 16. In some implementations, the rollers are so positioned relative to substrate plate 52, and relative to each other, that the rollers provide substantially all of the interface with material 28 at the end of trough 16.

In some implementations, rollers 54 provide a substantial and primary role in the interfacial contact with material 28, and substrate plate 52 plays a significant, though not primary, role in the contact with material 28. In still other embodiments, a substantial portion of substrate plate 52 comes in contact with material 28, while movement of the material is facilitated by a secondary degree of exposure of rollers 54 to material 28.

Whatever the relative relationship of rollers 54 and surface 58 to each other, end closure 30 provides the same working interface presentation to both the ends 26 of rolls 12, 14, and the open end of trough 16.

FIG. 8 also shows, in dashed outline, the projected circumferences of the working surfaces 31 of rolls 12, 14. In the embodiment illustrated in FIG. 8, rollers 54 extend the full width of trough 16 and extend, to a limited extent, beyond the width of the trough and overlap onto the edges of the ends of rolls 12, 14.

Rollers 54 are mounted to substrate plate 52. Those skilled in the art can readily fabricate a wide variety of support structures by which to mount rollers 54.

FIG. 9 shows a representative illustration of an end closure assembly 30 substantially the same as in FIG. 8, and which has all of the implementation potentials recited with respect to FIG. 8, except that substrate plate 52 has been truncated such that the substrate is generally confined to locations behind rollers 54 and generally follows the contours of the outer working surfaces 31 of rolls 12, 14. Accordingly, with the closure assembly mounted at an end of trough 16, with the rollers facing into the trough and toward material 28, any material which by-passes gap 22 and which moves laterally beyond an end of a roller, has no opportunity to become lodged between substrate plate 52 and the end of the respective roll 12 or 14.

FIG. 10 shows yet another representative illustration of an end closure assembly 30 of the invention, substantially the same as in FIG. 9 except that multiple rollers 54 are used end-to-end to extend along the full width of the end closure assembly at a given elevation. Accordingly, as material particles 28 at laterally-spaced locations at a given elevation, at the end of trough 16, move downwardly at different rates, the respective shorter rollers 54 at that given elevation can rotate at different rotational speeds which correspond more closely to the different downward speeds of advance of the material particles which contact the respective rollers.

FIG. 11 shows still another representative illustration of an end closure assembly 30 of the invention, which has many features in common with FIGS. 9 and 10. The lower rollers extend the full width of the closure assembly as in FIG. 9. The upper rollers extend less than the full width of the closure assembly as in FIG. 10. No more than 3 rollers are illustrated at any given nominal elevation on the end closure assembly 30. However, any number of rollers can be used at any given nominal elevation of the end closure.

FIG. 11 further distinguishes respective rollers at the upper portion of the end closure assembly in that central rollers 54C have generally horizontally oriented axes of rotation 62. Left end rollers 54L have ends which are proximate left ends 64L of central rollers 54C. Axes 62 of left end rollers 54L are angled downwardly from left ends 64L at angles α relative to the ends of rotation of central rollers 54C. Right end rollers 54R have ends which are proximate right ends 64R of central rollers 54C. Axes 62 of right end rollers 54R are also angled downwardly from right ends 64R at angles α relative to the axes of rotation of central rollers 54C. Angles a can all be the same magnitude from the axes of rotation of the respective central rollers 54C, or can vary. In some embodiments, the angles vary from elevation to elevation. The angles can also vary within a nominal elevation.

By orienting angled end rollers 54L and 54R at angles α relative to axis 62 of central rollers 54C, the directions of rotation of rollers 54L and 54R are brought into closer alignment with the directions of translational movement of particles of material 28 as the material moves progressively closer to the lateral centerline 66 of trough 16 in its progressive movement downwardly in the trough. Rollers or wheels 54 can be oriented at angles α in any embodiment which uses multiple rollers or wheels along a given nominal elevation.

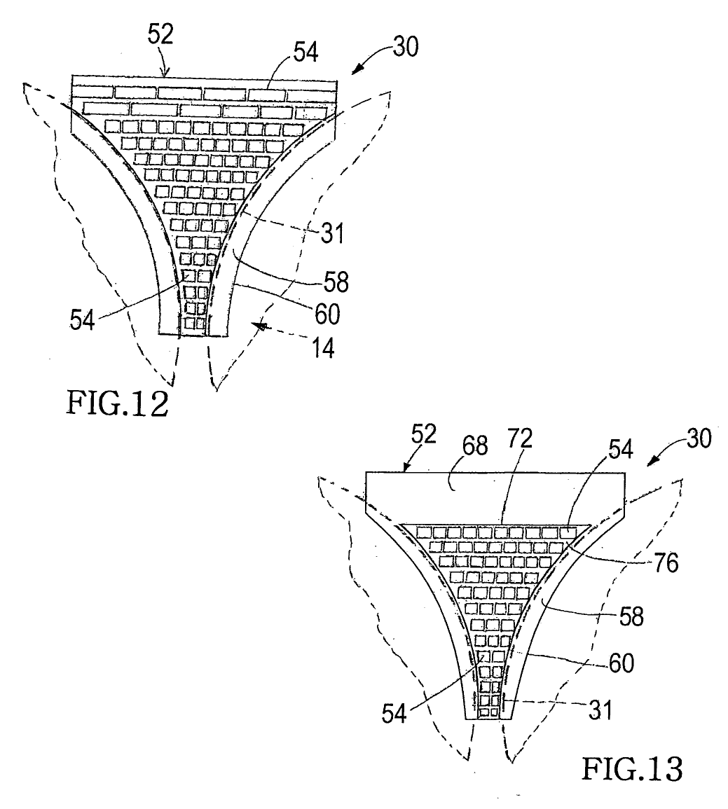

FIG. 12 shows yet another embodiment of end closure structure of the invention. In this embodiment, the rollers 54 which are located adjacent the top of the end closure are relatively longer, having lengths generally corresponding to the lengths represented at the upper portion of FIG. 10. However, the rollers 54 which are located away from the top of the end closure structure are substantially shorter thus to invoke nomenclature of “wheels”, as relatively shorter forms of “rollers”.

Edges 60 of substrate plate 52 extend beyond the projected outline of working surfaces 31 of rolls 12, 14, including where one of rolls 12, 14 is moving dynamically according to conventional hydraulic system forces which apply pressure to material 28 at and adjacent gap 22. Edge surface 58 of substrate plate 52 can be placed closely adjacent ends 26 of rolls 12, 14 thus to provide a first locus of interfacial relationship with the ends of rolls 12, 14.

Rollers 54 define a collective interface which interacts with material 28 at the end of the trough. The portions of the cylindrical surfaces of rollers 54, which are most remote from surfaces 58 of plate 52, define a second locus of interfacial relationship which generally represents an extension of surface 58, and which engages material 28 at the end of the trough. Thus, fixed/static surface 58 of plate 52 is positioned outside the trough, in generally the same location where working surfaces of conventional static cheek plates engage rolls 12, 14; and rollers 54 are disposed in generally the same location where working surfaces of conventional static cheek plates engage material 28.

Thus, the end closure structure of FIG. 12 provides a static interfacial surface which is in working relationship with the ends 26 of rolls 12, 14; and a moving interface, e.g. an interface defined by rotating rollers, which is in working relationship with material 28 in the trough.

FIG. 13 shows an end closure as in FIG. 12 and wherein a top portion of the end closure presents a stationary metal surface which interfaces with material 28 being worked, and wherein a bottom portion of the end closure presents wheels and/or rollers and/or balls which interface with the material being worked. In this embodiment, the substrate plate 52 presents a relatively upwardly-disposed stepped-out portion 68 and a relatively downwardly-disposed recessed portion 70, separated by a break line 72. Stepped-out portion 68 defines a general plane of engagement with material 28. Rollers or wheels or balls 54 are mounted in recessed portion 70 so as to present a second working interface, working with material 28, generally aligned with the working surface of upper portion 68. Accordingly, the material being worked can encounter the upper portion of the end closure at a given upright surface, and can move downwardly along the end closure, into interfacial relationship with the rollers 54 along a projection of the same upright surface. As in FIG. 12, edge surfaces 58 provide interfacial relationships between the end closures 30 and the ends 26 of rolls 12, 14. Such upper stationary portion can be applied to any of the other embodiments as desired.

Rollers 54 represent surface elements which move in sympathy with material 28 as the material is moving through trough 16 toward gap 22. In some embodiments, rollers 54 can be selected as balls mounted in respective sockets. Such balls can thus effect polyaxial rotation which follows any direction of movement of the material which is in contact with the respective ball at a particular period of time.

Where balls serve as the working interface, each ball is received in a socket so as to be able to rotate relative to any axis of rotation. Thus, any embodiment which employs balls as the working interface elements interfacing with material 28 has the advantage that the balls can readily change axes of rotation according to changes in direction of translational movement of that material 28 which is in contact with the given ball at a given time.

The embodiments represented by FIG. 11 represent a fixed axis compromise with conformity of the angle of rotation of the interface with direction of advance of material 28.

The invention thus provides three general designs of end closures, all of which provide movable interface elements which move in a direction generally consistent with movement of material 28 toward gap 22. FIGS. 3-7 show track-based end closures wherein the track translates downwardly as urged by material 28 and/or rolls 12, 14. FIGS. 8-13 show rotating rollers, wheels, or balls which rotate in place as urged by material 28.

End closures of the invention find application in substantially all implementations where high pressure comminuting rolls are used with conventional cheek plates. Typical industries which use high pressure comminuting rolls, and corresponding cheek plates, represent the manufacture of cement and the processing of mineral ores. It is also quite possible to use high pressure comminuting rolls, with such cheek plates, in processes of compacting products e.g. in the potash industry, recycling industry, and making briquettes, e.g. such as charcoal briquettes.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. Sizing apparatus adapted to modify particle size, said sizing apparatus comprising:
(a) first and second sizing rolls (12, 14), and a trough (16) therebetween adapted to receive material (28) to be worked by said sizing apparatus and wherein such material moves through the trough toward a gap (22) between said sizing rolls (12, 14); and
(b) an end closure adjacent first ends of said first and second sizing rolls, and generally closing off an end of the trough, said end closure comprising a support structure, and an array of interface elements spaced with respect to each other so as to provide, optionally in combination with said support structure, an effectively continuous contact surface to such material (28) being worked, said interface elements comprising working surfaces which move in cooperation with movement of such material (28) through such trough toward such gap.

2. Apparatus as in claim 1, said apparatus comprising first and second ones of said end closures, disposed at opposing ends of the trough so as to prevent solid particulate material in the trough from traveling through the ends of the trough and thus by-passing the gap.

3. Apparatus as in claim 1 wherein the moving surface elements rotate about respective axes of rotation.

4. Apparatus as in claim 1, said end closure comprising support structure, the moving of said moving surface elements comprising translational movement relative to said support structure.

5. Apparatus as in claim 1 wherein said sizing rolls comprise size reduction rolls.

6. Apparatus as in claim 1 wherein said sizing rolls comprise agglomeration rolls.

7. Apparatus as in claim 1, further comprising a second said end closure adjacent second ends of said first and second rolls, thereby generally closing off both first and second ends of the trough (16).

8. Apparatus as in claim 1 wherein said array of interface elements comprises an endless track.

9. Apparatus as in claim 1 wherein said array of interface elements comprises an array of rollers and wherein axes of rotation of said rollers are all generally parallel to each other.

10. Apparatus as in claim 1 wherein said array of interface elements comprises an array of rollers, wherein axes of rotation of a first set of said rollers are aligned with, and parallel to, each other and wherein axes of rotation of a second different set of said rollers are aligned with, and parallel to, each other and not parallel to the axes of rotation of the first set of said rollers.

11. Apparatus as in claim 1 wherein said array of interface elements comprises an array of rollers positioned, in combination, in end-to-end relationship to each other and in side-by-side relationship to each other.

12. Apparatus as in claim 1 wherein said array of interface elements comprises an array of balls mounted for polyaxial rotation.

13. Apparatus as in claim 12 wherein each said ball is mounted for polyaxial rotation.

14. An end closure assembly adapted and configured to close off an end of a material compacting trough between first and second sizing rolls, said end closure comprising:
(a) an endless track (32); and
(b) a support structure,
said endless track being mounted about said support structure, said support structure and said endless track, as so mounted, defining an endless path of travel of said track about said support structure.

15. An end closure as in claim 14, said endless path of travel comprising an engagement section (38) and a non-engagement section (40), a ratio of a height (H) to a width (W) of the engagement section being about 0.5/1 to about 2/1.

16. An end closure as in claim 14, said support structure comprising first and second end rotating elements, rotating on fixed axes of rotation and defining nodes of the endless path.

17. An end closure as in claim 16, further comprising intermediate support structure between the first and second end rotating elements, supporting the endless track along an engagement portion of the endless path.

18. An end closure as in claim 17 wherein said intermediate support structure comprises at least one intermediate rotating element supporting the endless track along an engagement portion of the endless path.

19. An end closure as in claim 17 wherein said intermediate support structure comprises a support plate supporting the endless track along an engagement portion of the endless path.

20. An end closure assembly adapted and configured to close off an end of a material compacting trough which leads to a gap of closest approach of first and second sizing rolls to each other, said end closure comprising:
(a) a support structure; and
(b) an array of interface elements spaced with respect to each other so as to provide, optionally in combination with said support structure, an effectively continuous contact surface to such material being worked, said interface elements comprising working surfaces which move in cooperation with movement of such material through such trough toward such gap.

21. An end closure assembly as in claim 20 wherein said array of interface elements comprises an endless track.

22. An end closure assembly as in claim 20 wherein said array of interface elements comprises an array of rollers, wherein axes of rotation of said rollers are all generally aligned with, or parallel to, each other.

23. An end closure assembly as in claim 20 wherein said array of interface elements comprises an array of rollers, wherein axes of rotation of a first set of said rollers are generally aligned with, or parallel to, each other, and wherein axes of rotation of a second set of said rollers are aligned with, or parallel to, each other and not aligned with, or parallel to, the axes of rotation of the second set of said rollers.

24. An end closure assembly as in claim 20 wherein said array of interface elements comprises an array of rollers positioned, in combination, in end-to-end relationship to each other and in side-by-side relationship with each other.

25. An end closure assembly as in claim 20 wherein said array of interface elements comprises an array of balls mounted for polyaxial rotation.

26. An end closure assembly as in claim 20 wherein each said ball is mounted for polyaxial rotation.

27. An end closure assembly as in claim 20 wherein said array of interface elements comprises an array of
(i) balls mounted for polyaxial rotation, and
(ii) rollers mounted for rotation about fixed axes of rotation.
